(19) United States
(12) Patent Application Publication
(10) Pub. No.: US 2006/0092786 A1
(43) Pub. Date: May 4, 2006

(54) Optical disk recording and reproducing device

(75) Inventor: Ryusuke Noda, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/262,834

(22) Filed: Nov. 1, 2005

(30) Foreign Application Priority Data
Nov. 4, 2004 (JP) P2004-321069

(51) Int. Cl. G11B 5/09

(52) U.S. Cl. 369/47.1; 369/275.4; 369/53.2

(57) ABSTRACT

Prior to a start of tilt regulation measurement and when a discriminated region is a mixed region, a photodetector is moved by a predetermined amount. And then, when the tilt regulation measurement is started, an objective lens of the photodetector is tilted to an inner end and an outer end to discriminate the region. When the region is a mixed region or states of the inner side and the outer side of the region are different as in a case where a recorded region and a non-recorded region coexist, the photodetector is moved by a predetermined amount in a similar manner to the above mentioned. The tilt regulation of the photodetector is performed on a basis of an RF signal and/or a tracking error signal read out after the photodetector is moved to a region other than the mixed region.

### BACKGROUND OF THE INVENTION

1. Field of the Invention

The present invention relates to an optical disk recording and reproducing device for performing information recording/information reproducing operations with respect to an optical disk and, in particular, the present invention relates to an optical disk recording and reproducing device having a function of correcting radial tilt of the optical disk.

2. Description of the Related Art

It has been usual that, in an optical disk recording and reproducing device, the radial tilt correction (referred to as “tilt correction”, hereinafter) for correcting tilt of the optical disk is performed in recording information in the disk or in reproducing information recorded in the optical disk. The “tilt correction” means a correction of tilt of a laser light outputted from a photodetector with respect to a recording plane of an optical disk and, in a state in which the tilt correction is made correctly, the laser light is vertically incident on the recording plane of the optical disk.

Particularly, in order to record information in an optical disk such as DVD-R (writable optical disk) or DVD-RW (writable/rewritable optical disk), the tile correction is indispensable in view of specifications thereof. As the method of the tilt correction, a method, by which the tilt is corrected by using a tilt sensor for detecting tilt of an optical disk and regulating tilt of a photodetector with respect to the optical disk by an output of the tilt sensor, and a method, by which the tilt correction is performed by detecting a signal read out from the optical disk such as an RF signal or a tracking error signal read out from a photodetector and using a portion of the signal, amplitude level of which becomes maximum, are known.

In the tilt correction using the tilt sensor, however, there is a problem that a size and cost of the photodetector are increased due to the use of the tilt sensor. On the other hand, in the tilt correction using the signal read out from the optical disk such as the RF signal or the tracking error signal without using additional part such as a tilt sensor, when the tilt correction is performed by using a region of the optical disk, from which the RF signal or the tracking error signal is measured and which includes a recorded region, a non-recorded region and a mixed region where a recorded region and a non-recorded region are mixed, the amplitude level of the signal to be measured is not constant, so that there is a problem that reliability of result of correction is considerably lowered. Further, even if the measuring position is out of the mixed region and when amplitude level of the tracking error signal is measured by canceling a tracking servo, it is necessary to consider that a condition, in which the objective lens of the photodetector is tilted toward an inside end, is different from a condition, in which the objective lens is tilted toward an outside end, due to influence of eccentricity of the optical disk. Without this consideration, there is a problem that the reliability of the result of correction becomes worse.

Incidentally, in the techniques disclosed in JP-A-2004-39247 and JP-A-2004-95035, in the mixed region, of the optical disk, where the region where information is recorded and the region where information is not recorded are mixed, since reflectivity of a non-recorded region is higher than that of a recorded region, the amplitude level of the tracking error signal read out from the non-recorded region becomes higher. Therefore, the amplitude level becomes partially high and partially low when the tracking error signal is measured in the mixed region, resulting in that, even when these amplitude levels are averaged, it is impossible to know maximum level and it is impossible to normally correct tilt even if such tracking error signal is used for tilt correction.

### SUMMARY OF THE INVENTION

The present invention was made in order to solve the above mentioned problems and an object of the present invention is to provide an optical disk recording and reproducing device having a function of normally performing a tilt correction even for an optical disk in which there are recorded regions and non-recorded regions in mixed state.

In order to achieve the above object, a first aspect of the present invention provides an optical disk recording and reproducing device characterized by including a system controller which includes a region discrimination unit for setting a threshold value to around an intermediate value between an amplitude level of an RF signal read out from a non-recorded region of the optical disk by the photodetector and an amplitude level of the RF signal read out from a recorded region of the optical disk by the photodetector, counting the RF signals having amplitude levels equal to or higher than the threshold value, and the RF signals having amplitude levels equal to or lower than the threshold value, in every constant cycle of one revolution of the optical disk and discriminating the region as a non-recorded region when the number of the RF signals read out from the region by the photodetector and having amplitude levels equal to or higher than the threshold value is 0, as the recorded region when the number of the RF signals read out from the region by the photodetector and having amplitude levels lower than the threshold value is 0 and as a mixed region when the region includes non-recorded area and recorded area, a first photodetector control unit for performing, prior to a start of tilt regulation measurement, a control for moving the photodetector to an outer peripheral direction of the optical disk by a predetermined amount when a position of the photodetector is on an inner peripheral side and a control for moving the photodetector in an inner periphery direction by a predetermined amount when the position of the photodetector is on an outer periphery side and when the region discriminated by the region discrimination unit is a mixed region, a second photodetector control unit, which, when the tilt regulation measurement is started, discriminates a region by the region discrimination unit by tilting an objective lens of the photodetector toward an inner end and an outer end and, when this region is a mixed region or when an inner side and outer side states of this region are different as in a case where the region includes a recorded region and a non-recorded region, performs a control for moving the photodetector similarly to that performed by the first photodetector control unit and a tilt regulation unit for regulating tilt of the photodetector on a basis of an RF signal and/or a tracking error signal read out from other region than a mixed region by moving the photodetector under control of the second photodetector control unit.

In this construction, the optical disk rotates and the number of RF signals amplitude levels equal to or higher than the threshold value and the number of RF signals having amplitude levels equal to or lower than the threshold value are counted by the region discrimination unit in every constant cycle of one revolution of the optical disk and the region is discriminated as a non-recorded region when the number of the RF signals read out from the region by the photodetector and having amplitude levels equal to or higher than the threshold value is 0, as a recorded region when the number of the RF signals read out from the region by the photodetector and having amplitude levels lower than the threshold value is 0 and as a mixed region when the region includes both of a non-recorded region and a recorded region.

Prior to the start of the tilt regulation measurement, the first photodetector control unit performs, when the region discriminated by the region discrimination unit is a mixed region and when a position of the photodetector is on an inner peripheral side of the disk, the control for moving the photodetector in an output peripheral direction of the disk by a predetermined amount. When the position of the photodetector is on the outer peripheral side of the disk, a control for moving the photodetector in an inner peripheral direction of the disk by a predetermined amount is performed.

When the tilt regulation measurement is started, a region is determined by the region determination unit by tilting an objective lens of the photodetector toward an inner end and an outer end and, when this region is a mixed region or when an inner side and outer side states of this region are different as in a case where the region includes a recorded region and a non-recorded region, the second photodetector control unit performs a control for moving the photodetector similarly to that performed in the first photodetector control unit.

The photodetector is moved under control of the second photodetector control unit and the tilt regulation unit performs the tilt regulation of the photodetector on a basis of the RF signal and/or the tracking error signal read out from a region, which is not a mixed region.

According to this construction, it is possible that the tilt regulation unit performs the tilt regulation of the photodetector on a basis of the RF signal and/or the tracking error signal read out from a region, which is not a mixed region. Therefore, it is possible to normally perform the tilt correction without adding any special tilt regulation device and without influence of the mixed region even for an optical disk in which there are recorded regions and non-recorded regions in mixed state and to improve the recording preciseness and reproducing preciseness.

A second aspect of the present invention provides an optical disk recording and reproducing device, characterized by including a system controller for discriminating a region as a mixed region including a recorded area and a non-recorded area on a basis of the amplitude level of RF signal read out from the optical disk by the photodetector, moving the photodetector by a predetermined amount when the region is a mixed region and regulating tilt of the photodetector on a basis of an RF signal and/or a tracking error signal read out from a region, which is not a mixed region.

In this construction, when the region of the optical disk, which is read out from the optical disk by the photodetector, is a mixed region, the photodetector is moved by a predetermined amount and the tilt regulation of the photodetector is performed on a basis of an RF signal and/or a tracking error read out from other region than a mixed region.

According to this construction, since it is possible to regulate tilt of the photodetector on a basis of an RF signal and/or a tracking error signal read out from a region, which is not a mixed region, it is possible to normally perform the tilt correction without adding a special tilt regulation device and without influence of mixed region even for an optical disk in which there are recorded regions and non-recorded regions in mixed state, and to improve the recording preciseness and reproducing preciseness.

In third aspect of the present invention, the system controller of the second aspect further includes the region discrimination unit for discriminating a region as a non-recorded region when there is no RF signal read out from the region by the photodetector and having amplitude level equal to or higher than the threshold value, as a recorded region when there is no RF signal read out from the region by the photodetector and having amplitude level lower than the threshold value and as a mixed region when the region includes both of non-recorded region and recorded region, the first photodetector control unit for moving, prior to a start of a tilt regulation measurement, the photodetector by a predetermined amount when the region discriminated by the region discrimination unit is a mixed region, the second photodetector control unit for performing a control for tilting an objective lens of the photodetector toward an inner end and an outer end to discriminate the region by the region discrimination unit when the tilt regulation measurement is started and moving the photodetector by a predetermined amount when the region is a mixed region or when states of an inside and an out side of the region are different as in a case where a recorded region and a non-recorded region coexist and the tilt regulation unit for regulating tilt of the photodetector on a basis of an RF signal and/or a tracking error signal read out from other region than a mixed region by moving the photodetector under control of the second photodetector control unit.

In this construction, the optical disk is rotated and the region discrimination unit discriminates a region as a non-recorded region when there is no RF signal read out by the photodetector and having amplitude level equal to or higher than the threshold value, as a recorded region when there is no RF signal having amplitude level lower than the threshold value and as a mixed region when there are both regions in the region.

In a case where the region is discriminated as the mixed region by the region discrimination unit, the first photodetector control unit moves the photodetector by the predetermined amount prior to the start of the tilt regulation measurement.

The second photodetector control unit performs the control for tilting an objective lens of the photodetector toward an inner end and an outer end to discriminate the region by the region discrimination unit when the tilt regulation measurement is started and moving the photodetector by a predetermined amount when the region is a mixed region or when states of an inside and an out side of the region are different as in a case where a recorded region and a non-recorded region coexist.

The photodetector is moved under control of the second photodetector control unit and the tilt regulation unit regulates tilt of the photodetector on a basis of an RF signal and/or a tracking error signal read out from other region than a mixed region.

According to this construction, it is possible to perform the tilt regulation of the photodetector on a basis of the RF signal and/or the tracking error signal read out from other region than a mixed region.

In the fourth aspect of the present invention, in the system controller of the third aspect, the region discrimination unit sets a threshold value to around an intermediate level between an amplitude level of an RF signal read out from a non-recorded region of the optical disk by the photodetector and an amplitude level of an RF signal read out from a recorded region of the optical disk by the photodetector, counts RF signals having amplitude levels equal to or higher than the threshold value and RF signals having amplitude levels equal to or lower than the threshold value, in every constant cycle of one revolution of the optical disk and discriminates the region as a non-recorded region when the number of the RF signals read out by the photodetector and having amplitude levels equal to or higher than the threshold value is 0, as a recorded region when the number of RF signals read out by the photodetector and having amplitude levels lower than the threshold value is 0 and as a mixed region when non-recorded region and recorded region coexist. Therefore, it is possible to correctly discriminate the non-recorded region, the recorded region and the mixed region of the optical disk.

In the fifth aspect of the present invention, in the system controller of the third aspect, the first photodetector control unit performs, prior to the start of the tilt regulation measurement, a control for moving the photodetector to an outer peripheral direction of the disk by a predetermined amount when a position of the photodetector is on an inner peripheral side and a control for moving the photodetector in an inner periphery direction by a predetermined amount when the position of the photodetector is on an outer periphery side, in a case where the region discriminated by the region discrimination unit is a mixed region. Therefore, the tilt regulation of the photodetector can be performed on a basis of RF signal and/or tracking error signal from the region other than the mixed region.

As mentioned above, the present invention includes the system controller including the region discrimination unit, which sets the threshold value to around an intermediate value between amplitude level of RF signal read out from a non-recorded region of the optical disk by the photodetector and amplitude level of RF signal read out from a recorded region of the optical disk by the photodetector, counts the number of RF signals having amplitude levels equal to or higher than the threshold value or higher and the number of RF signals having amplitude levels equal to or lower than the threshold value, in every constant cycle of one revolution of the optical disk and discriminates the region as a non-recorded region when the number of the RF signals read out from the region read out by the photodetector and having amplitude levels equal to or higher than the threshold value is 0, the region as a recorded region when the number of the RF signals read out from the region by the photodetector and having amplitude levels lower than the threshold value is 0 and the region including non-recorded region and recorded region as a mixed region, the first photodetector control unit, which performs, prior to a start of tilt regulation measurement, a control for moving the photodetector in an outer peripheral direction of the disk by a predetermined amount when a position of the photodetector is on an inner peripheral side and a control for moving the photodetector in an inner periphery direction by a predetermined amount when the position of the photodetector is on an outer periphery side and the region discriminated by the region discrimination unit is a mixed region, the second photodetector control unit, which, when the tilt regulation measurement is started, discriminates a region by the region discrimination unit by tilting the objective lens of the photodetector toward an inner end and an outer end and, when this region is a mixed region or when an inner side and outer side states of this region are different as in a case where the region includes a recorded region and a non-recorded region, performs a control for moving the photodetector similarly to that performed in the first photodetector control unit and the tilt regulation unit for regulating tilt of the photodetector on an RF signal and/or a tracking error signal read out from other region than a mixed region by moving the photodetector under control of the second photodetector control unit. Therefore, it is possible to perform the tilt regulation of the photodetector on a basis of the RF signal and/or the tracking error signal read out from the region, which is not the mixed region, to thereby normally perform the tilt correction without adding any special tilt regulation device and without influence of the mixed region even for an optical disk in which recorded regions and non-recorded regions are mixed and to improve the recording preciseness and reproducing preciseness.

Further, since the present invention includes the system controller, which discriminates a region from a mixed region, a recorded region and a non-recorded region read out by the photodetector on a basis of amplitude levels of RF signals, moves the photodetector by a predetermined amount when the region is the mixed region and regulates tilt of the photodetector on a basis of an RF signal and/or a tracking error signal read out from other region, which is not a mixed region. Therefore, it is possible to perform the tilt regulation of the photodetector on a basis of the RF signal and/or the tracking error signal read out from other region than the mixed region to thereby normally perform the tilt correction without adding any special tilt regulation device and without influence of the mixed region even for an optical disk in which recorded regions and non-recorded regions are coexist and to improve the recording preciseness and reproducing preciseness.

Further, the present invention includes the system controller including the region discrimination unit for discriminating a region as a non-recorded region when there is no RF signal read out from the region by the photodetector and having amplitude level equal to or higher than the threshold value, as a recorded region when there is no RF signal read out by the photodetector and having amplitude level lower than the threshold value and as a mixed region when the region includes both of non-recorded region and recorded region, the first photodetector control unit for moving, prior to a start of a tilt regulation measurement, the photodetector by a predetermined amount when the region discriminated by the region discrimination unit is a mixed region, the second photodetector control unit for performing a control for tilting the objective lens of the photodetector toward an inner end and an outer end to discriminate the region by the region discrimination unit when the tilt regulation measurement is started and moving the photodetector by a predetermined amount when the region is a mixed region or when states of an inside and an out side of the region are different as in the case where a recorded region and a non-recorded region coexist and the tilt regulation unit for regulating tilt of the photodetector on a basis of an RF signal and/or a tracking error signal read out from other region than the mixed region by moving the photodetector under control of the second photodetector control unit. Therefore, it is possible to perform the tilt regulation of the photodetector on a basis of the RF signal and/or the tracking error signal read out from a region, which is not the mixed region, to thereby normally perform the tilt correction without adding any special tilt regulation device and without influence of the mixed region even for an optical disk, in which recorded regions and non-recorded regions are mixed, and to improve the recording preciseness and reproducing preciseness.

### BRIEF DESCRIPTION OF THE DRAWINGS

FIG. 1 is a block circuit diagram showing a construction of an optical disk recording and reproducing device according to an embodiment of the present invention;

FIG. 2 shows waveforms of an RF signal and a tracking error (TE) signal used in a tilt regulation in the embodiment;

FIG. 3 is a flowchart showing a processing performed prior to a start of tilt regulation measurement in the optical disk recording and reproducing device of the embodiment;

FIG. 4 is a flowchart showing a processing performed when the tilt regulation measurement is started in the optical disk recording and reproducing device of the embodiment; and

FIG. 5 shows a recording region for explaining recording regions of a DVD-R or DVD-RW in the embodiment.

### DETAILED DESCRIPTION OF THE INVENTION

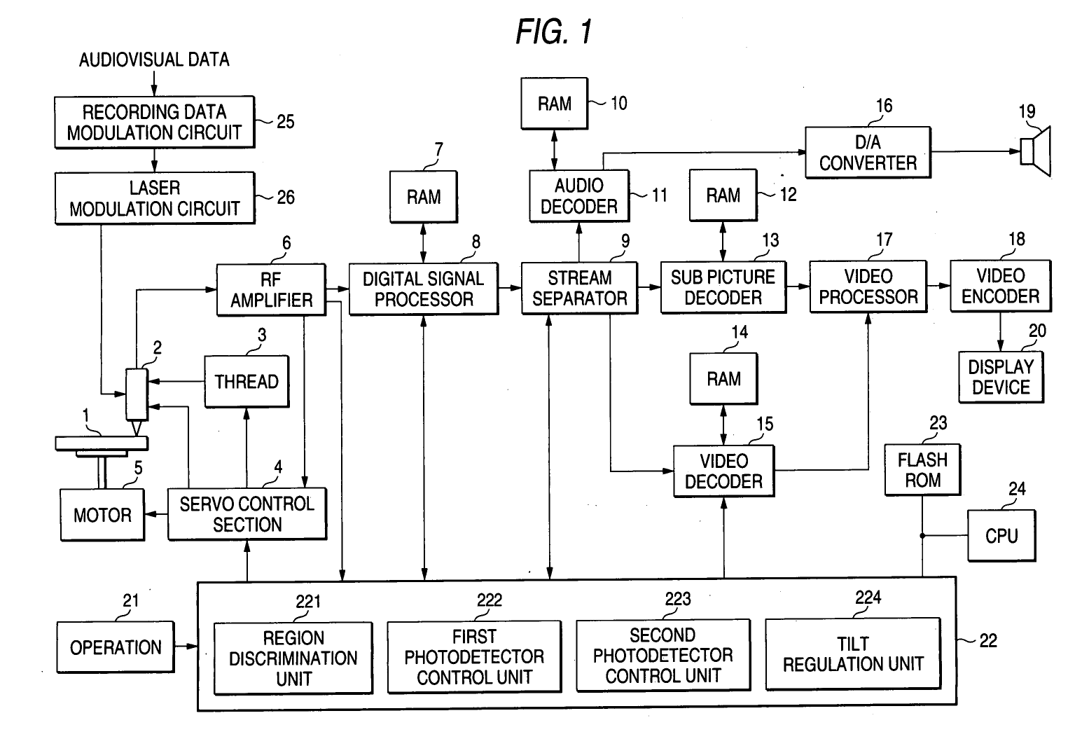

Embodiments of the present invention will be described with reference to the accompanying drawings. FIG. 1 is a block circuit diagram showing a construction of an optical disk recording and reproducing device according to an embodiment of the present invention.

The optical disk recording and reproducing device includes a spindle motor 5 for rotating an optical disk 1, a photodetector 2, which emits laser light for recording information in the optical disk 1, reproduces information recorded in the optical disk 1 and receives reflection light from the optical disk 1, a sled 3 for moving the photodetector 2 in radial direction of the optical disk 1 and a servo control section 4 for moving a focal position of the laser light vertically and horizontally with respect to a recording surface of the optical disk 1 by driving the spindle motor 5 and the sled 3 according to an instruction of a system controller 22 and by moving an objective lens (not shown) housed in the photodetector 2 and regulating tilt of the objective lens.

The optical disk recording and reproducing device includes an RF amplifier 6 for amplifying RF signal, which is a read signal from the photodetector during reproduction of the optical disk 1, a digital signal processor 8 for storing data, which is produced by converting the RF signal outputted from the RF amplifier 6 into digital data, and performing a signal demodulation processing according to data format of the optical disk 1, and an error correction processing in an RAM 7 and a stream separator 9 for separating audio data, sub picture data and video data from a data stream outputted from the digital signal processor 8 according to an instruction of the system controller 22.

Further, the optical disk recording and reproducing device includes an audio decoder 11 for decoding audio data outputted from the stream separator 9 in a predetermined manner, an RAM 10 for temporarily storing data for performing the decoding processing in the audio decoder 11, a sub picture decoder 13 for inputting a sub picture data outputted from the stream separator 9 to decode in a predetermined manner, an RAM 12 for temporarily storing data necessary to perform the decoding processing in the sub picture decoder 13, a video decoder 15 for inputting video data outputted from the stream separator 9 to decode and an RAM 14 for temporarily storing data necessary to perform the decoding processing in a video decoder 15.

Further, this optical disk recording and reproducing device includes a video processor 17 for synthesizing data outputted from the video decoder 15 and data outputted from the sub picture decoder 13 according to an instruction from the system controller 22, a video encoder 18 for displaying an image, which is obtained by converting the synthesized data outputted from the video processor 17 into a video signal for display, on the display device 20 and a D/A converter 16 for converting the data outputted from the audio decoder 11 into an analog audio signal and supplying it to, for example, a loud speaker 19.

Further, this optical disk recording and reproducing device includes an operation section 21 having various operation keys such as a recording key for giving a recording instruction to the system controller 22, a reproducing key for giving a reproducing instruction thereto, a stop key for giving a stop instruction thereto, etc., and the system controller 22 for controlling the whole device. Incidentally, the operation section 21 may be a remote controller or a mathematical operation section provided on an operation panel of the device body.

Further, the this optical disk recording and reproducing device includes a flash ROM 23 storing program and data for controlling various components of the device and controlling the whole device and a CPU 24 for controlling the system controller 22 by performing mathematical operation processing, according to the program and data in the flash ROM 23.

Further, the this optical disk recording and reproducing device includes a recording data modulation circuit 25 for modulating audiovisual data transmitted from a television receiver or a personal computer, which are not shown, to record the audiovisual data in the optical disk 1 and a laser modulation circuit 26 for outputting a laser modulation signal for modulating laser light emitted from the photodetector 2 on a basis of the data modulated by the recording data modulator circuit 25.

The system controller 22 includes, as constructive components characterizing this embodiment, a region discrimination unit 221 for setting a threshold value to around an intermediate value between an amplitude level of an RF signal read out from a non-recorded region of the optical disk 1 by the photodetector 2 and an amplitude level of an RF signal read out from a recorded region of the optical disk 1 by the photodetector 2, counting RF signals having amplitude levels equal to or higher than the threshold value, and RF signals having amplitude levels equal to or lower than the threshold value, in every constant cycle of one revolution of the optical disk 1 and discriminating the region as a non-recorded region when the number of the RF signals read out from the region by the photodetector 2 and having amplitude levels equal to or higher than the threshold value is 0, the region as a recorded region when the number of the RF signals read out by the photodetector 2 and having amplitude levels lower than the threshold value is 0 and the region as a mixed region when non-recorded region and recorded region coexist in the region and a first photodetector control unit 222, which performs, prior to a start of tilt regulation measurement, a control for moving the photodetector 2 in an outer peripheral direction of the disk by a predetermined amount when a position of the photodetector 2 is on an inner peripheral side and a control for moving the photodetector in an inner periphery direction by a predetermined amount when the position of the photodetector 2 is on an outer periphery side and when the region is discriminated by the region discrimination unit as a mixed region.

Further, the system controller 22 includes a second photodetector control unit 223, which, when the tilt regulation measurement is started, causes the region discrimination unit 221 to discriminate a region by tilting an objective lens of the photodetector 2 toward an inner end and an outer end and, when this region is a mixed region or when an inner side and outer side states of this region are different as in a case where recorded region and non-recorded region coexist in the region, performs a control for moving the photodetector 2 similarly to that performed in the first photodetector control unit and a tilt regulation unit 224 for regulating tilt of the photodetector 2 on a basis of an RF signal and/or a tracking error read out from other region than a mixed region by moving the photodetector 2 under control of the second photodetector control unit 223.

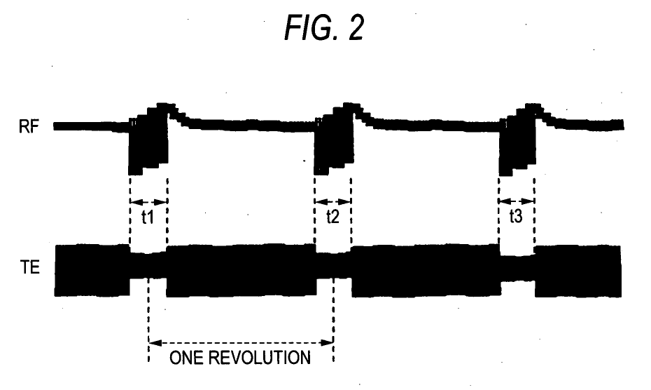

FIG. 2 shows waveforms of the RF signal and the tracking error (TE) signal used in tilt regulation in this embodiment. The RF signal is outputted from the photodetector 2 for reading information in the optical disk 1. Amplitude level of the RF signal read out when information is recorded in the optical disk 1 becomes as large as, for example, 0.9 Vp-p, and amplitude level of the RF signal read out when information is not recorded in the optical disk 1 becomes as small as, for example, 0 Vp-p. The tracking error signal, in this case, is a signal from the photodetector 2, which is obtained when the tracking servo of the servo control portion 4 is made off and the optical disk 1 is rotated without moving the photodetector 2. As will be clear from FIG. 2, the amplitude level of the tracking error signal is small with respect to time periods t1, t2 and t3, during which the amplitude level of the RF signal is large.

Since the optical disk 1 has eccentricity and the track is spirally formed, the amplitude level of the tracking error signal during one revolution of the optical disk 1 becomes constant and is changed depending upon the tilt angle of the photodetector 2. Since, when information is recorded in the optical disk 1, reflectivity of laser light is reduced in the periods t1, t2 and t3, in which the RF signal is outputted, the amplitude level of the tracking error signal becomes small. Considering one revolution of the optical disk 1, the mixed region, in which a recorded region and a non-recorded region coexist, includes a portion in which the RF signal exists and a portion in which no RF signal exist.

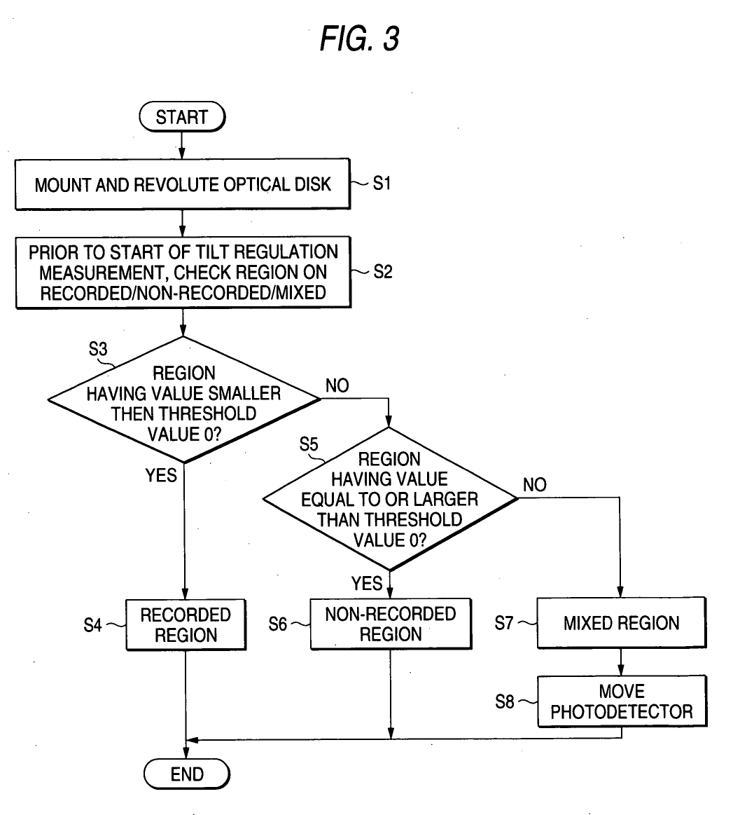

FIG. 3 is a flowchart of a processing to be executed prior to the start of the tilt regulation measurement in the optical disk recording and reproducing device of this embodiment. The processing prior to the tilt regulation measurement will be described with reference to this flowchart.

First, the optical disk 1 is mounted on the optical disk recording and reproducing device and is rotated (Step S1) and then the operation is shifted to the discrimination of regions of the optical disk 1 between recorded/non-recorded/mixed regions, prior to the start of the tilt regulation measurement (Step S2). That is, the region discrimination unit 221 of the system controller 22 sets a threshold value to around an intermediate value between an amplitude level of an RF signal read out from a non-recorded region of the optical disk 1 by the photodetector 2 and an amplitude level of the RF signal read out from a recorded region of the optical disk by the photodetector 2, counts the RF signals having amplitude levels equal to or higher than the threshold value and the RF signals having amplitude levels lower than the threshold value, in every constant period in one revolution of the optical disk 1 and, when the number of the RF signals read out from the region by the photodetector 2 and having amplitude levels equal to or higher than the threshold value is 0 (Step S3), discriminates the region as a non-recorded region (Step S6), and, when the number of the RF signals having amplitude levels lower than the threshold value (Step S3), discriminates the region as a recorded region (Step S4) and, when there are both recorded region and non-recorded region coexist in the region, discriminates the region as a mixed region (Step S7).

This discrimination of region is necessary for the measurement in a constant region (recorded region or non-recorded region) other than mixed region. In order to discriminate the mixed region, the RF signal is used. The amplitude level of the RF signal depends on the device. For example, the amplitude level of the RF signal read out from the non-recorded region is nearly 0 Vp-p and the amplitude level of the RF signal read out from the recorded region is about 0.9 Vp-p. The region is discriminated by using the difference in amplitude level between the recorded region and the non-recorded region.

When the region is discriminated as a mixed region (Step S7), the first photodetector control unit 222 of the system controller 22 moves the sled 3 through the servo control section 4 to move the photodetector 2 mounted on the sled 3 (Step S8). Considering eccentricity of the optical disk 1, an amount of movement may be, for example, 300 μm or more.

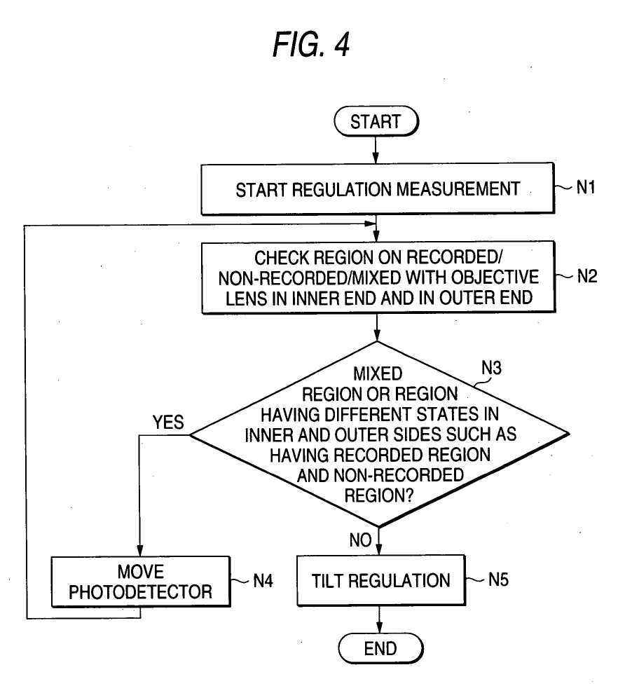

FIG. 4 is a flowchart for explaining a processing when the tilt regulation is started in the optical disk recording and reproducing device of this embodiment. The processing when the tilt regulation measurement is started will be described with reference to this flowchart.

When the regulation measurement is started (Step N1), the system controller 22 drives a tilt coil within the photodetector 1 through the servo control section 4 and then the operation is shifted to a discrimination processing for discriminating the region to be read by the photodetector 1 as a non recorded region or a mixed region by tilting the objective lens of the photodetector 1 toward an inner and outer ends (Step N2).

That is, when the tilt regulation measurement is started and the objective lens of the photodetector 2 is tilted to the inner end and the outer end, the region discrimination unit 221 of the system controller 22 discriminates a region to be read by the photodetector 2. When this region is a mixed region or when an inside and outside states thereof are different as a case where it includes both recorded region and non-recorded region (Step N3), the second photodetector control unit 223 performs a control for moving the photodetector 2 similarly to the manner mentioned previously (Step N4). Incidentally, when a construction for tilting the whole photodetector 2 is used, in lieu of a case where only the objective lens of the photodetector 2 is tilted by the tilt coil, it is enough to tilt only the sled 3. Therefore, a mechanism for tilting the sled 3 may be driven.

The photodetector 2 is moved in this manner (Step N4) and the steps N2 and N3 are performed. In a case where the discriminated region is a region other than a mixed region or an inside and outside states thereof are different as in the case where there are recorded region and non-recorded region in the region, the tilt regulation is performed (Step N5). That is, the tilt regulation unit 224 of the system controller 22 moves the photodetector 2 under control of the second photodetector control unit 223 and performs the tilt regulation of the photodetector 2 on a basis of the RF signal and/or the tracking error signal read out from the region other than the mixed region. Incidentally, the RF signal and the tracking error signal are read out from the recorded region and only the tracking error signal is read out from the non-recorded region.

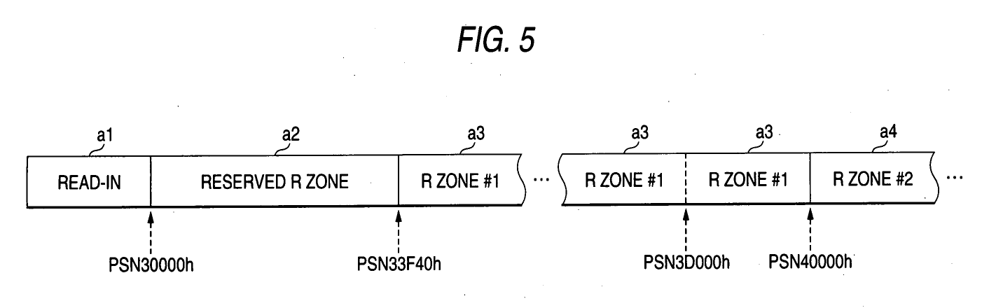

FIG. 5 shows an example of recording regions of a DVD-R or a DVD-RW in this embodiment. In FIG. 5, PSN30000h (corresponding to zero), PSN33F40h, PSN3D000h and PSN40000h are logical sector numbers corresponding to addresses on the DVD. In FIG. 5, a1 depicts a read-in region, a2 depicts a region of reserved R zone, a3 depicts a region of R zone #1 and a4 depicts a region of R zone #2.

Information is usually written in an optical disk starting from an inner periphery thereof toward an outer periphery thereof. However, in order to record the disk information in a VRmode (recording mode) of the DVD-R or DVD-RW, the constant region (region a2 of reserved R zone) starting at PSN30000h is left as a non-recorded region until the recording is finalized. Further, in a write-once state, a head portion of lastly recorded R zone is in non-recorded state. For example, in a case where information is recorded to the middle (PSN3D000h) of the R zone #1 and information is additionally recorded starting from the R zone #2, the head portion (in this example, in a range from PSN3D000h to PSN40000h of the R zone #1) of the R zone #2 is left as a non-recorded.

In a case in which the optical disk is recorded as mentioned above, it is probable that a tilt regulation position in a region, which may be in either inner periphery or outer periphery of the region, becomes a recorded region or a non-recorded region or a mixed region. In a case where the region is a mixed region and tilt is regulated in the region in the inner peripheral side of the optical disk, for example, in the region PSN40000h, in order to avoid the mixed region, probability of changing the mixed region to a recorded region is high by moving the tilt regulation position to the outer side of the disk. On the other hand, in a case of tilt regulation in the outer peripheral side of the optical disk, the probability of changing the mixed region to a recorded region is high by moving the tilt regulation position to the inner side of the disk. Therefore, it is possible to move to the position suitable for tilt regulation by one movement of the photodetector 2.

As described hereinbefore, according to this embodiment, it is possible to perform the tilt regulation of the photodetector on a basis of the RF signal and/or the tracking error signal read out from a region other than the mixed region. Therefore, it is possible to normally perform the tilt correction without adding a special tilt regulation device even for an optical disk in which recorded regions and non-recorded regions are mixed, without influence of the mixed region and to improve the recording preciseness and reproducing preciseness.

What is claimed is:

1. An optical disk recording and reproducing device including a photodetector for optically writing information in an optical disk and reading out information recorded in an optical disk, that performs recording and reproducing operations with respect to the optical disk, comprising:
a system controller including:
a region discrimination unit that sets a threshold value to around an intermediate value between an amplitude level of an RF signal read out from a non-recorded region of the optical disk by the photodetector and an amplitude level of an RF signal read out from a recorded region of the optical disk by the photodetector, counts the number of RF signals having amplitude levels equal to or higher than the threshold value and RF signals having amplitude levels equal to or lower than the threshold value, in every constant cycle of one revolution of the optical disk, and discriminates a region as a non-recorded region when the number of the RF signals read out from the region by the photodetector and having amplitude levels equal to or higher than the threshold value or higher is 0, the region as a recorded region when the number of the RF signals read out from the region by the photodetector and having amplitude levels lower than the threshold value is 0 and the region as a mixed region when the region includes both of a non-recorded region and a recorded region;
a first photodetector control unit that performs, prior to a start of tilt regulation measurement, a control for moving the photodetector in an outer peripheral direction of the disk by a predetermined amount when a position of the photodetector is on an inner peripheral side, and a control for moving the photodetector in an inner periphery direction by a predetermined amount when the position of the photodetector is on an outer periphery side and when the region discriminated by the region discrimination unit is a mixed region;
a second photodetector control unit that discriminates, when the tilt regulation measurement is started, a region by the region discrimination unit by tilting an objective lens of the photodetector toward an inner end and an outer end, and performs, when this region is a mixed region or when an inner side and outer side states of this region are different as in a case where it includes a recorded region and a non-recorded region, a control for moving the photodetector similarly to that performed by the first photodetector control unit; and
a tilt regulation unit that regulates tilt of the photodetector on a basis of an RF signal and/or a tracking error signal read out from other region than a mixed region by moving the photodetector according to the control of the second photodetector control unit.

2. An optical disk recording and reproducing device including a photodetector for optically writing information in an optical disk and reading out information recorded in an optical disk, that performs recording and reproducing operations with respect to the disk, comprising:
a system controller that discriminates a region as a mixed region including a recorded region and a non-recorded region on a basis of amplitude levels of the RF signal read out from the region by the photodetector, moves the photodetector by a predetermined amount when the region is a mixed region, and regulates tilt of the photodetector on a basis of an RF signal and/or a tracking error signal read out from other region than a mixed region.

3. The optical disk recording and reproducing device as claimed in claim 2,
wherein the system controller further comprising:
a region discrimination unit that discriminates the region as a non-recorded region when the amplitude level of the RF signal read out from the region by the photodetector is equal to or higher than the threshold value, as recorded region when there is no RF signal read out from the region by the photodetector and having amplitude level lower than the threshold value and as mixed region when the region includes both of a non-recorded region and a recorded region;
a first photodetector control unit that moves, prior to a start of a tilt regulation measurement, the photodetector by a predetermined amount when the region discriminated by the region discrimination unit is a mixed region;
a second photodetector control unit that performs, when the tilt regulation measurement is started, a control for tilting an objective lens of the photodetector toward an inner end and an outer end to discriminate the region by the region discrimination unit, and moves the photodetector by a predetermined amount when the region is a mixed region or when the region includes different states of an inside and an out side portions of the region as in a case where the region includes a recorded region and a non-recorded region; and
a tilt regulation unit that regulates tilt of the photodetector on a basis of an RF signal and/or a tracking error signal read out from other region than the mixed region by moving the photodetector under control of the second photodetector control unit.

4. The optical disk recording and reproducing device as claimed in claim 3,
wherein the region discrimination unit sets a threshold value to around an intermediate value between an amplitude level of the RF signal read out from a non-recorded region of the optical disk by the photodetector and an amplitude level of the RF signal read out from a recorded region of the optical disk by the photodetector, counts the RF signals having amplitude levels equal to or higher than the threshold value and the RF signals having amplitude levels equal to or lower than the threshold value, in every constant cycle of one revolution of the optical disk and discriminates the region as a non-recorded region when the number of the RF signals read out from the region by the photodetector and having amplitude levels equal to or higher than the threshold value is 0, the region as a recorded region when the number of the RF signals read out from the region by the photodetector and having amplitude levels lower than the threshold value is 0 and the region as a mixed region when the region includes a non-recorded region and a recorded region.

5. The optical disk recording and reproducing device as claimed in claim 3,
wherein the first photodetector control unit performs, prior to the start of the tilt regulation measurement, a control for moving the photodetector to an outer peripheral direction of the disk by a predetermined amount when a position of the photodetector is on an inner peripheral side and a control for moving, when the region discriminated by the region discrimination unit is a mixed region, the photodetector in an inner periphery direction by a predetermined amount when a position of the photodetector is on an outer periphery side.
